(19) United States
(12) Patent Application Publication
(10) Pub. No.: US 2024/0143963 A1
(43) Pub. Date: May 2, 2024

(54) INFORMATION PROCESSING APPARATUS, METHOD, AND STORAGE MEDIUM STORING PROGRAM

(71) Applicant: CANON KABUSHIKI KAISHA, Tokyo (JP)

(72) Inventor: TORU SHINNAE, Tokyo (JP)

(21) Appl. No.: 18/493,960

(22) Filed: Oct. 25, 2023

(30) Foreign Application Priority Data
Oct. 28, 2022 (JP) 2022-173655

(51) Int. Cl. G06K 15/02; G06K 15/00

(52) U.S. Cl. CPC G06K 15/027; G06K 15/002

(57) ABSTRACT

An information processing apparatus comprises: an acquisition unit configured to acquire information of an image forming apparatus; a display control unit configured to, based on the information of the image forming apparatus acquired by the acquisition unit, display a setting screen for setting a schedule by which to execute a color verification, wherein the color verification includes a plurality of steps, and the display control unit, based on the information of the image forming apparatus, specifies which steps can be executed without a user operation from the start of the color verification among the plurality of steps, and based on the specified steps, displays on the setting screen a selection candidate for a step to be executed when a scheduled time arrives.

### BACKGROUND OF THE INVENTION

### Field of the Invention

The present invention relates to an information processing apparatus for verifying color quality of a printed matter, a method, and a storage medium storing a program.

### Description of the Related Art

As a method for verifying the color quality of a printed matter printed by an image forming apparatus, there is a process in which a chart on which several color patches are printed is read by a colorimeter, and the read information is compared with a printing industry color standard/reference or a color standard/reference independently established by a printing company. In this process, the color quality is typically verified by calculating an average color difference of all patches and a maximum color difference in all patches from the result of the comparison, and determining whether these are equal to or less than tolerance values set in advance by a user. In addition to the average color difference and the maximum color difference, conditions may be determined based on various considerations.

There are functions for scheduling tasks such as color verification to be executed on specific days/times. Further, there are functions for setting when the color quality of an image forming apparatus is to be corrected based on the result of the color verification (Japanese Patent Laid-Open No. 2016-224749).

### SUMMARY OF THE INVENTION

The color verification operations that can be performed without user operation differ depending on the image forming apparatus. The present invention provides an information processing apparatus that can flexibly set a color verification operation to be performed by an image forming apparatus when a scheduled time arrives, a method, and a storage medium for storing a program.

The information processing apparatus according to the present invention in one aspect provides an information processing apparatus, the apparatus comprising: at least one memory and at least one processor which function as: an acquisition unit configured to acquire information of an image forming apparatus; a display control unit configured to, based on the information of the image forming apparatus acquired by the acquisition unit, display a setting screen for setting a schedule by which to execute a color verification, wherein the color verification includes a plurality of steps, and the display control unit, based on the information of the image forming apparatus, specifies which steps can be executed without a user operation from the start of the color verification among the plurality of steps, and based on the specified steps, displays on the setting screen a selection candidate for a step to be executed when a scheduled time arrives.

By virtue of the present invention, it is possible to flexibly set a color verification operation to be executed by the image forming apparatus when a scheduled time arrives.

Further features of the present invention will become apparent from the following description of exemplary embodiments with reference to the attached drawings.

### BRIEF DESCRIPTION OF THE DRAWINGS

FIG. 1 is a view illustrating a system configuration.

FIG. 2 is a block diagram illustrating a control configuration of each apparatus.

FIG. 3 is a block diagram illustrating a software configuration of each apparatus.

FIG. 4 is a diagram illustrating information necessary for color verification.

FIG. 5 is a diagram illustrating information necessary for color verification.

FIG. 6 is a diagram illustrating capability information of an image forming apparatus.

FIG. 7 is a diagram illustrating color settings necessary for color verification.

FIG. 8 is a diagram illustrating a color verification schedule setting screen.

FIG. 9 is a diagram illustrating information stored when a schedule setting is performed.

FIGS. 10A and 10B are flowcharts illustrating a process at a time of performing a color verification schedule setting.

FIGS. 11A and 11B are flowcharts illustrating a process executed in a case where a scheduled time arrives.

FIG. 12 is a diagram illustrating a color verification schedule setting screen.

FIG. 13 is a diagram illustrating information stored when a schedule setting is performed.

FIGS. 14A and 14B are flowcharts illustrating a process at a time of performing a color verification schedule setting.

FIG. 15 is a diagram illustrating a screen with a list of scheduled color verifications that have been executed.

FIG. 16 is a screen displayed in a case where “notification only” is set.

FIG. 17 is a screen displayed in a case where “print” is set.

FIG. 18 is a screen displayed in a case where “print & colorimetry” is set.

FIG. 19 is a flowchart illustrating a display control process that follows execution of a scheduled color verification.

FIG. 20 is a diagram illustrating a color verification schedule setting screen.

FIG. 21 is a diagram illustrating information stored when a schedule setting is performed.

FIGS. 22A and 22B are flowcharts illustrating a process at a time of performing a color verification schedule setting.

FIG. 23 is a flowchart illustrating a process of restricting execution of a job other than the color verification job.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate.

Furthermore, in the attached drawings, the same reference numerals are given to the same or similar configurations, and redundant description thereof is omitted.

### First Embodiment

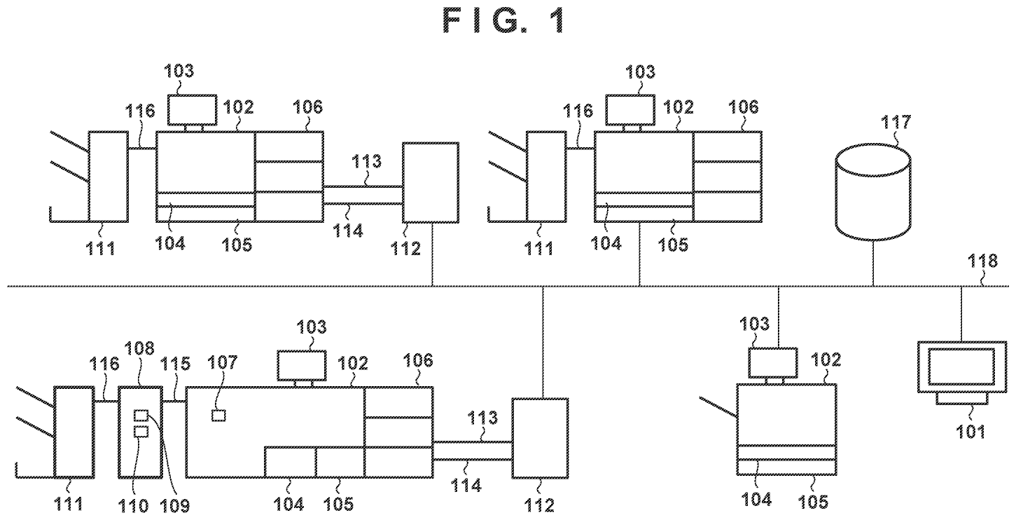

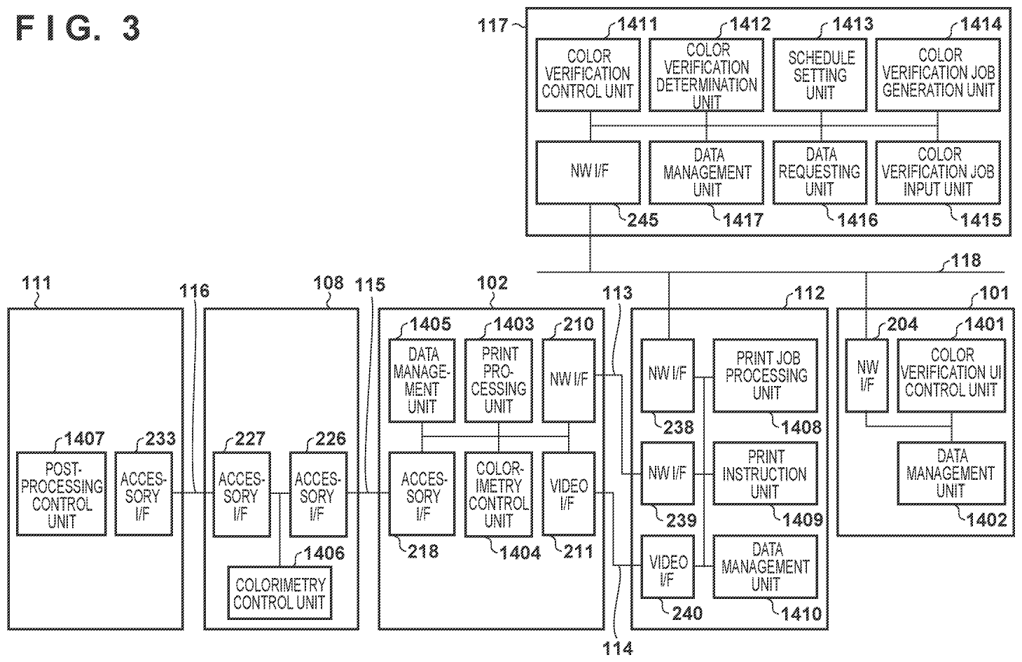

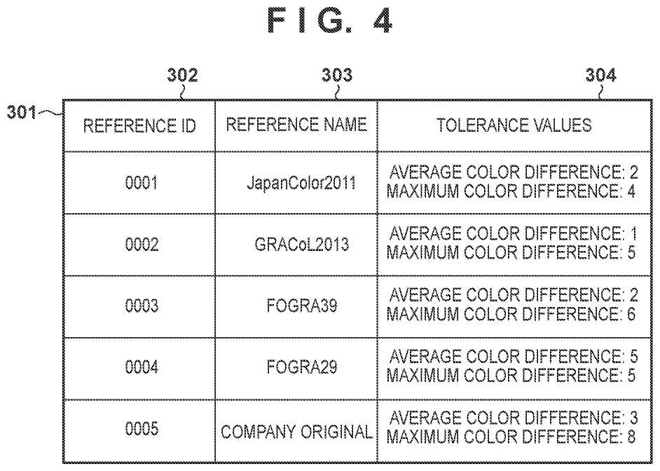

FIG. 1 is a diagram illustrating an example of a system configuration including a client computer, an image forming apparatus, an image processing apparatus, and a color management server according to the present embodiment. A client computer 101 is connected via a network 118 to an image processing apparatus 112 and a color management server 117, which are on the same network. Information necessary for color verification (described later in FIG. 4) and color verification results are stored in the color management server 117 on the network, and the information is transmitted to the client computer 101 via the network 118. The information necessary for the color verification and color verification results may be stored and managed in the client computer 101 instead of the color management server 117 on the network. Further, at the time of color verification, the client computer 101 issues instructions to print a chart in which color patches for color verification are arranged, and to perform colorimetry, to the image processing apparatus 112 via the network 118 based on the set information, and thereby performs color verification. These are executed by a control unit described later with reference to FIG. 3. In the present embodiment, color verification is treated as including a plurality of steps. For example, color verification includes at least a step of notifying that the color verification is performed, a step of printing a chart, and a step of performing colorimetry on the printed chart.

An image forming apparatus 102 is connected to the image processing apparatus 112 via a cable 113 and a cable 114. The image forming apparatus 102 includes a UI panel 103, a sheet feeding deck 104, a sheet feeding deck 105, and a spectroscopic sensor 107. Further, an optional deck 106 including three sheet feeding cassettes is connected. The image forming apparatus 102 is, for example, an electrophotographic image forming apparatus. The UI panel 103 is, for example, a user interface including a capacitive touch panel. The spectroscopic sensor 107 is a sensor that irradiates a substance with light and acquires information by measuring reflection, scattering, and absorption of a spectrum thereof, and colorimetry on a printed matter can be performed using the sensor.

The image forming apparatus 102 further includes an automatic adjustment unit 108 and a sheet discharge apparatus 111. The automatic adjustment unit 108 is connected to the image forming apparatus 102 via a cable 115. Furthermore, the automatic adjustment unit 108 includes two types of sensors: a spectroscopic sensor 109 and a contact image sensor (CIS) 110. The spectroscopic sensor 109 has the same role as the spectroscopic sensor 107 included in the image forming apparatus 102. The CIS 110 is an image reading sensor. The sheet discharge apparatus 111 is connected to the image forming apparatus 102 or the automatic adjustment unit 108 via a cable 116. Further, the sheet discharge apparatus 111 includes several sheet discharging trays, and is capable of loading a product printed by the image forming apparatus 102.

A job is generated by the client computer 101, transmitted to the image processing apparatus 112 via the network 118, and managed by the image processing apparatus 112. Then, the job is transmitted from the image processing apparatus 112 to the image forming apparatus 102 via the cable 113 and the cable 114, and the image forming apparatus 102 performs a process of printing on a printing medium such as a sheet. The job may be generated by the image processing apparatus 112, transmitted to the image forming apparatus 102 via the cable 113 and the cable 114, and managed by the image forming apparatus 102. In addition, a plurality of image forming apparatuses 102 may be present on the network 118. The image forming apparatus 102 may be directly connected to the network 118.

Note that the embodiment of connections of the client computer 101, the image forming apparatus 102, the image processing apparatus 112, and the color management server 117 illustrated in the present embodiment is merely an example, and embodiments of connections other than that illustrated in the present embodiment may be adopted.

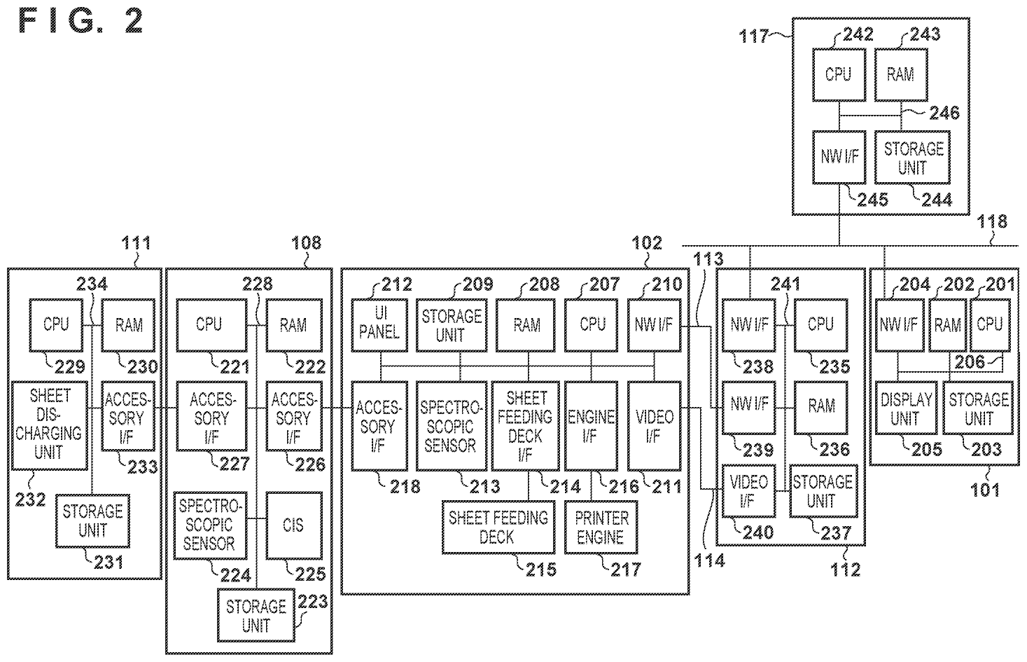

FIG. 2 is a block diagram illustrating an example of a control configuration of the client computer 101, the image forming apparatus 102, the image processing apparatus 112, and the color management server 117. A central processing unit (CPU) 201 is responsible for control and computation for the respective units in the client computer 101 via a system bus 206. The CPU 201 is responsible for executing a program that is stored in a storage unit 203 and loaded into Random Access Memory (RAM) 202. The RAM 202 is a type of typical volatile storage device that can be directly accessed from the CPU 201 and is used as a work area of the CPU 201 or as a temporary data storage region. The storage unit 203 functions as a temporary storage region and a working memory for when the client computer 101 operates. A network interface (NW I/F) 204 is connected to an NW I/F 238 of the image processing apparatus 112 on the network via the network 118, and is responsible for communication between the client computer 101 and the image processing apparatus 112. The NW I/F 204 is connected to an NW I/F 245 of the color management server 117 on the network via the network 118, and is responsible for communication between the client computer 101 and the color management server 117. A display unit 205 is a hardware configuration and is a user interface for visually showing information in the client computer 101. For example, the display unit 205 is a monitor display.

A CPU 207 is responsible for control and calculation for the respective units in the image forming apparatus 102 via a system bus 219. The CPU 207 is stored in a storage unit 209 and is responsible for executing a program to be loaded into a RAM 208. The RAM 208 is a type of typical volatile storage device that can be directly accessed from the CPU 207 and is used as a work area of the CPU 207 or as a temporary data storage region. The storage unit 209 functions as a temporary storage region and a working memory for when the image forming apparatus 102 operates.

An NW OF 210 is connected to an NW OF 239 of the image processing apparatus 112 via the cable 113, and is responsible for communication between the image processing apparatus 112 and the image forming apparatus 102. A video OF 211 is connected to a video OF 240 via the video cable 114, and is responsible for the communication of image data between the image processing apparatus 112 and the image forming apparatus 102. A UI panel 212 is a hardware configuration of the UI panel 103 and is a user interface for general user operation of the image forming apparatus 102. In the present embodiment, it is assumed that the UI panel 212 includes a capacitive touch panel. A spectroscopic sensor 213 is a hardware configuration of the spectroscopic sensor 107, and performs colorimetry on a printed matter printed by the image forming apparatus 102.

A sheet feeding deck OF 214 controls communication with a sheet feeding deck 215. The sheet feeding deck 215 is a collective term for the sheet feeding decks 104 and 105 and the optional deck 106, as a hardware configuration. An engine OF 216 controls communication with a printer engine 217. An accessory OF 218 is connected to an accessory OF 226 and an accessory OF 233 via the cable 115 and the cable 116. That is, the image forming apparatus 102 communicates with the automatic adjustment unit 108 and the sheet discharge apparatus 111 via the accessory I/Fs 218, 226 and 233.

A CPU 221 is responsible for control and calculation for the respective units in the automatic adjustment unit 108 via a system bus 228. The CPU 221 is stored in a storage unit 223 and is responsible for executing a program to be loaded into a RAM 222. The RAM 222 is a type of typical volatile storage device that can be directly accessed from the CPU 221 and is used as a work area of the CPU 221 or as a temporary data storage region. The storage unit 223 functions as a temporary storage region and a working memory for a colorimetry operation and an adjustment operation. A spectroscopic sensor 224 is a hardware configuration of the spectroscopic sensor 109, and performs colorimetry on a printed matter printed by the image forming apparatus 102. A CIS 225 is a hardware configuration of the CIS 110 and captures a printed matter printed by the image forming apparatus 102. The accessory OF 226 connects to the accessory OF 218 via the cable 115 and controls communication between the automatic adjustment unit 108 and the image forming apparatus 102. An accessory OF 227 connects to the accessory OF 233 via the cable 116 and controls communication between the automatic adjustment unit 108 and the sheet discharge apparatus 111.

A CPU 229 is responsible for control and calculation for the respective units in the sheet discharge apparatus 111 via the system bus 234, and execution of programs stored in a storage unit 231 and loaded into a RAM 230. The RAM 230 is a type of typical volatile storage device that can be directly accessed from the CPU 229 and is used as a work area of the CPU 229 or as a temporary data storage region. The storage unit 231 functions as a temporary storage region and a working memory for when the sheet discharge apparatus 111 operates. A sheet discharging unit 232 is responsible for a sheet discharging operation to a sheet discharging tray included in the sheet discharge apparatus 111 and monitors and controls a stacking state of each tray. The accessory OF 233 is connected to the accessory OF 218 and the accessory OF 227 via the cable 115 and the cable 116. That is, the sheet discharge apparatus 111 communicates with the image forming apparatus 102 and the automatic adjustment unit 108 via the accessory I/Fs 233, 218, and 227.

A CPU 235 is responsible for control and calculation for the respective units in the image processing apparatus 112 via a system bus 241, and execution of programs stored in a storage unit 237 and loaded into a RAM 236. The RAM 236 is a type of typical volatile storage device that can be directly accessed from the CPU 235 and is used as a work area of the CPU 235 or as a temporary data storage region. The storage unit 237 functions as a temporary storage region and a working memory for when the image processing apparatus 112 operates. The NW OF 238 is connected to the NW I/Fs 204 and 245 via the network 118. The image processing apparatus 112 communicates with the client computer 101 via the NW OF 238 and the NW OF 204. The image processing apparatus 112 communicates with the color management server 117 via the NW OF 238 and the NW OF 245. The NW OF 239 is connected to the NW OF 210 of the image forming apparatus 102 via the cable 113, and is responsible for communication between the image processing apparatus 112 and the image forming apparatus 102. The video OF 211 is connected to the video I/F 240 via the video cable 114, and is responsible for the communication of image data between the image processing apparatus 112 and the image forming apparatus 102.

A CPU 242 is responsible for control and calculation for the respective units in the color management server 117 via a system bus 246. The CPU 242 is stored in a storage unit 244 and is responsible for executing a program to be loaded into a RAM 243. The RAM 243 is a type of typical volatile storage device that can be directly accessed from the CPU 242 and is used as a work area of the CPU 242 or as a temporary data storage region. The storage unit 244 functions as a temporary storage region and a working memory for when the color management server 117 operates. The NW OF 245 is connected to the NW OF 204 of the client computer 101 on the network via the network 118 and is responsible for the communication between the color management server 117 and the client computer 101. The NW OF 245 is connected to the NW OF 238 of the image processing apparatus 112 on the network via the network 118, and is responsible for communication between the color management server 117 and the image processing apparatus 112.

FIG. 3 is a software block diagram illustrating an example of a connection system of the control units of the client computer 101, the image forming apparatus 102, the automatic adjustment unit 108, the sheet discharge apparatus 111, the image processing apparatus 112, and the color management server 117.

The client computer 101 includes a color verification UI control unit 1401 and a data management unit 1402, and the color verification UI control unit 1401 is present in the RAM 202 of the client computer 101 or the storage unit 203. The color verification UI control unit 1401 is called by the CPU 201 of the client computer 101 and performs UI control for color verification setting and execution, and schedule setting. The data management unit 1402 is called by the CPU 201 of the client computer 101 and temporarily manages data relating to color verification setting and execution, and schedule setting in the client computer 101.

The image forming apparatus 102 includes a print processing unit 1403, a colorimetry control unit 1404, and a data management unit 1405, which are present in the RAM 208 or the storage unit 209 of the image forming apparatus 102 and are executed by the CPU 207. The print processing unit 1403 is called by the CPU 207 of the image forming apparatus 102 and performs print processing. The colorimetry control unit 1404 is called by the CPU 207 of the image forming apparatus 102 and performs control for colorimetry on color patches printed on a printing medium such as a sheet. The data management unit 1405 is called by the CPU 207 of the image forming apparatus 102 and manages configuration information, capability information, and print job data of the image forming apparatus 102.

The automatic adjustment unit 108 comprises a colorimetry control unit 1406, which resides in the RAM 222 or the storage unit 223 of the automatic adjustment unit 108 and is executed by the CPU 221. The colorimetry control unit 1406 is called by the CPU 221 of the automatic adjustment unit 108 and performs control for colorimetry on color patches printed on a printing medium such as a sheet.

The sheet discharge apparatus 111 includes a post-processing control unit 1407. The post-processing control unit 1407 is present in the RAM 230 of the sheet discharge apparatus 111 or the storage unit 231, and is executed by the CPU 229. The post-processing control unit 1407 is called by the CPU 229 of the sheet discharge apparatus 111, and discharges the printed matter to the tray.

The image processing apparatus 112 includes a print job processing unit 1408, a print instruction unit 1409, and a data management unit 1410, which are each present in the RAM 236 or the storage unit 237 and are executed by the CPU 235. The print job processing unit 1408 is called by the CPU 235 of the image processing apparatus 112 and performs raster image processing (RIP) of a received print job. The print instruction unit 1409 is called by the CPU 235 of the image processing apparatus 112, transmits a job that has been processed by the image processing apparatus 112 to the image forming apparatus 102, and instructs the execution of print processing. The data management unit 1410 is called by the CPU 235 of the image processing apparatus 112 and manages capability information, and print job data of the image forming apparatus 102 and the image processing apparatus 112.

The color management server 117 includes a color verification control unit 1411, a color verification determination unit 1412, a schedule setting unit 1413, a color verification job generation unit 1414, a color verification job input unit 1415, a data request unit 1416, and a data management unit 1417. Each of these is present in the RAM 243 or the storage unit 244, and is executed by the CPU 242. The color verification control unit 1411 is called by the CPU 242 of the color management server 117, and controls processes necessary for color verification such as downloading and printing of a chart when performing color verification, and colorimetry on a chart. The color verification determination unit 1412 is called by the CPU 242 of the color management server 117, and performs color verification by comparing the results of colorimetry on a color verification chart with reference values stored in the storage unit 244 of the color management server 117. The schedule setting unit 1413 is called by the CPU 242 of the color management server 117, and performs setting for scheduling the days/times on which the color verification is to be executed, and information that is set is stored in the storage unit 244. The color verification job generation unit 1414 is called by the CPU 242 of the color management server 117 and creates a job for which color settings for color verification have been made. Hereinafter, a job for color verification may be referred to as a color verification job or a print job. The color verification job input unit 1415 is called by the CPU 242 of the color management server 117, and inputs a color verification job generated by the color verification job generation unit 1414 to the image forming apparatus 102 or the image processing apparatus 112. The data request unit 1416 is called by the CPU 242 of the color management server 117, and executes an instruction to the image forming apparatus 102 or the image processing apparatus 112 for acquiring the capability information of the image forming apparatus 102 or the image processing apparatus 112. The data management unit 1417 is called by the CPU 242 of the color management server 117, and manages the reference information for color verification, color verification results, capability information of the image forming apparatus 102 or the image processing apparatus 112, and the data of the schedule setting of the color verification in the storage unit 244 of the color management server 117.

FIG. 4 to FIG. 7 are diagrams illustrating examples of information necessary for color verification and capability information of image forming apparatuses stored in the color management server 117. This information is stored in the storage unit 244 of the color management server 117. FIG. 4 is a diagram illustrating color reference information for when performing color verification. A table 301 is a table indicating what kind of information the color reference to be used when performing color verification is stored as. An item 302 is ID information for identifying the stored color reference. Although a four-digit number is illustrated in the present example, it is merely an example, and various other methods of identifying the reference such as a combination of random characters may be used. An item 303 indicates a name of a stored color reference. An item 304 indicates what tolerance values, such as the average color difference, the maximum color difference, and the like, have been set in the stored color reference. Although only the average color difference and the maximum color difference are illustrated in this example, various other tolerance values such as the average color difference of a gray region may be used.

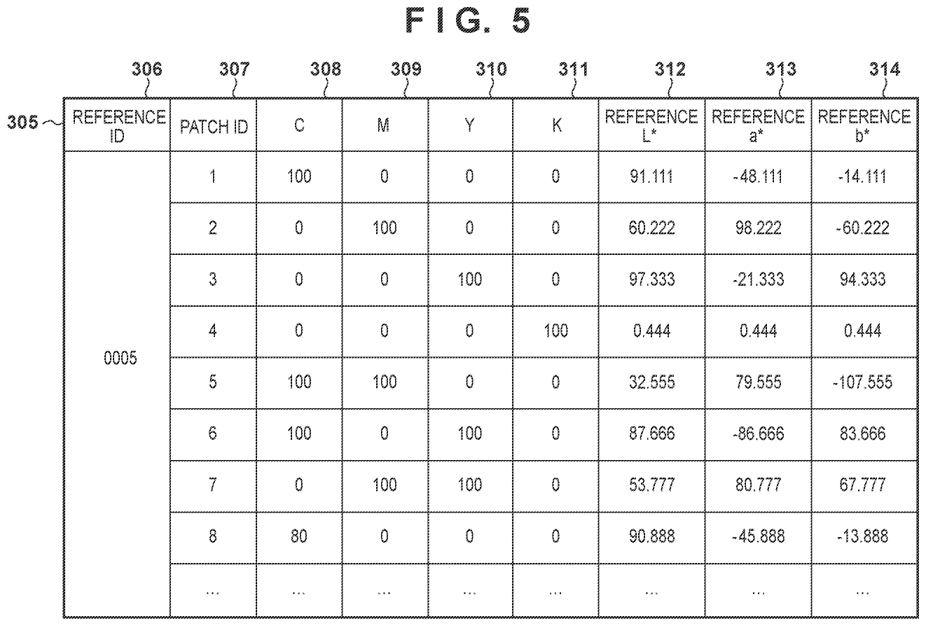

FIG. 5 is a diagram illustrating information indicating which color reference values are held for various color patches in each color reference illustrated in FIG. 4. A table 305 specifies what reference values a color reference has for which color patch. An item 306 is ID information for indicating which color reference table it is. In this example, it can be seen that it is a “company original” color reference when the table 305 is searched for an ID matching the item 302 of FIG. 4. An item 307 is ID information for identifying the color patch. Items 308, 309, 310, and 311 indicate Cyan (C), Magenta (M), Yellow (Y), and Black (K), respectively, where a signal value between 0 and 100 is stored. The items 312, 313, and 314 respectively indicate reference values (Lab values) in Lab color space corresponding to combinations of CMYK signal values. In this example, L=91.111, a=−48.111, and b=−14.111 are set as the reference values when the signal values of C=100 and M/Y/K=0 are combined. These reference values are set to different values for each color reference.

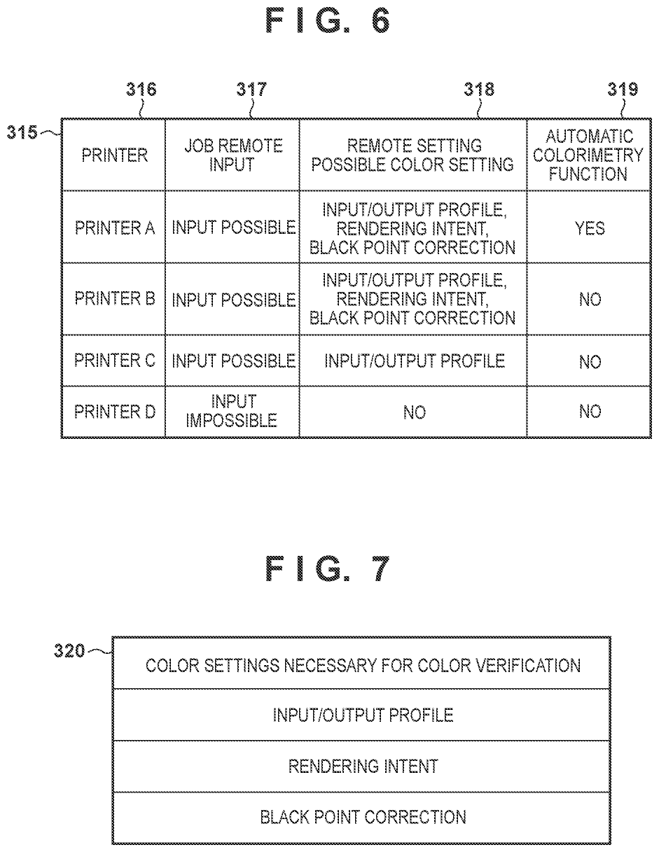

FIG. 6 is a diagram illustrating capability information of the image forming apparatus 102 to be subjected to color verification. A table 315 is a table that defines what configuration and capabilities image forming apparatuses 102 to be subjected to the color verification have. An item 316 indicates a type of the image forming apparatus 102 to be subjected to color verification. An item 317 indicates capability information as to whether or not a color verification job can be remotely input to the image forming apparatus 102 of item 316 using a function such as JDF (Job Definition Format). In other words, for example, the item 317 indicates whether or not each image forming apparatus 102 of the item 316 supports a job in which a JDF job step or the like is defined.

An item 318 is an item indicating which color settings can be remotely set for the image forming apparatus 102 of the item 316. In other words, the item 318 indicates what color settings can be set for a color verification job to be transmitted to the image forming apparatus 102 of the item 316. In the present embodiment, settings for the job to be transmitted to the image forming apparatus 102 are expressed as remote settings for the image forming apparatus 102. An item 319 indicates whether or not the image forming apparatus 102 of the item 316 has a mechanism for performing colorimetry on a color patch for color verification printed by execution of a color verification job when executing the color verification job. According to the example of FIG. 6, a color verification job can be remotely input to the printer A and the printer A has a mechanism for automatically performing colorimetry on a color patch for color verification. In addition, color settings such as an input/output profile, a rendering intent, and a black point correction can be remotely set for the image forming apparatus 102.

FIG. 7 is a diagram illustrating information indicating color settings necessary when executing a color verification job. A table 320 indicates what color settings are necessary for color verification. In the example of FIG. 7, three color settings—an input/output profile, a rendering intent, and a black point correction—are given as color settings necessary for color verification. The rendering intent indicates how processing is performed in the conversion of a color space (color gamut compression or the like). Black point correction is one type of dynamic range correction.

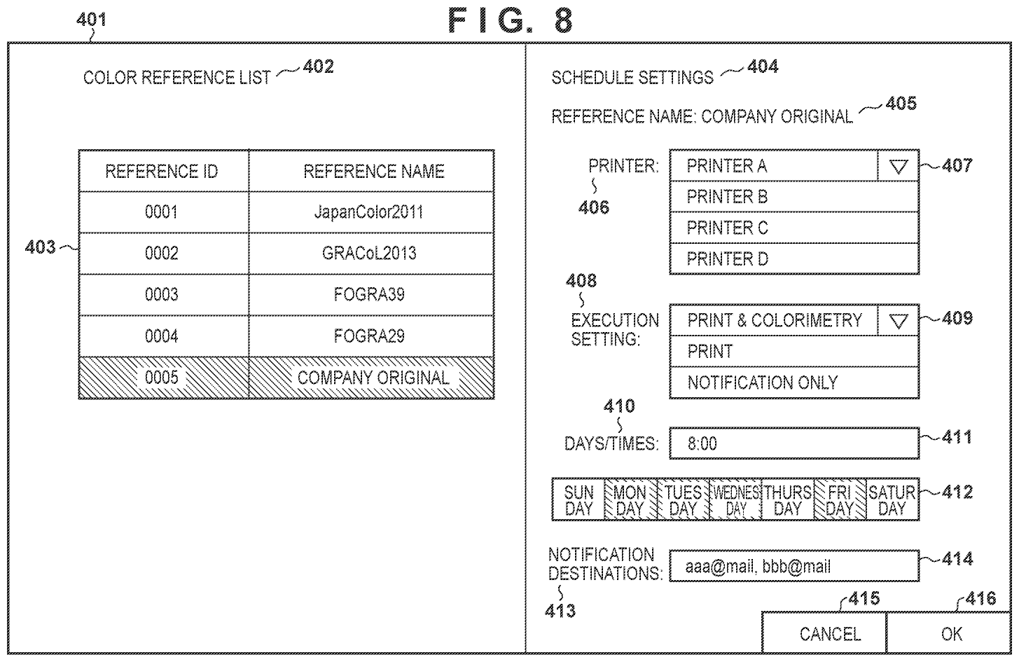

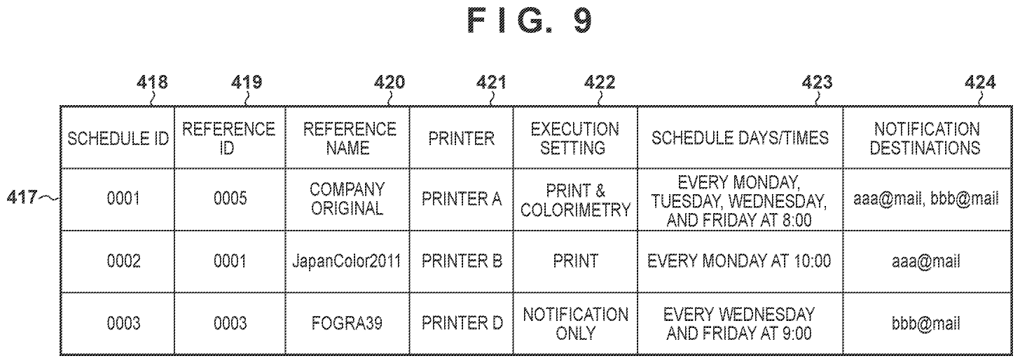

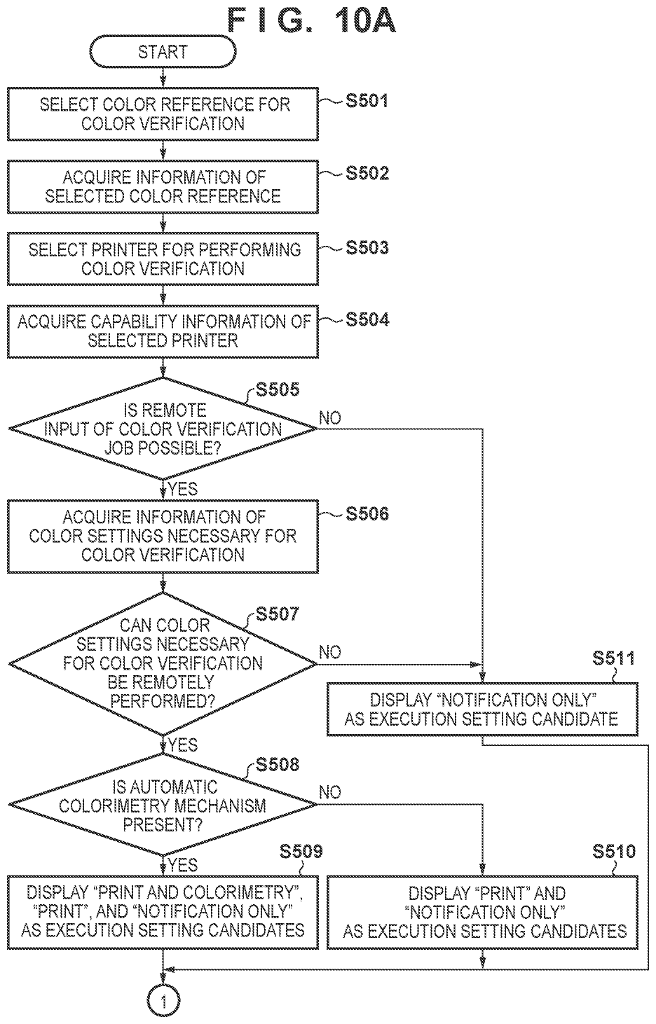

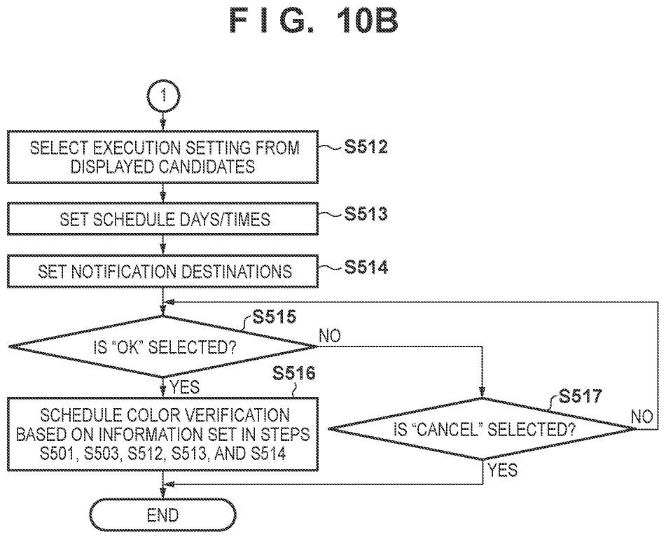

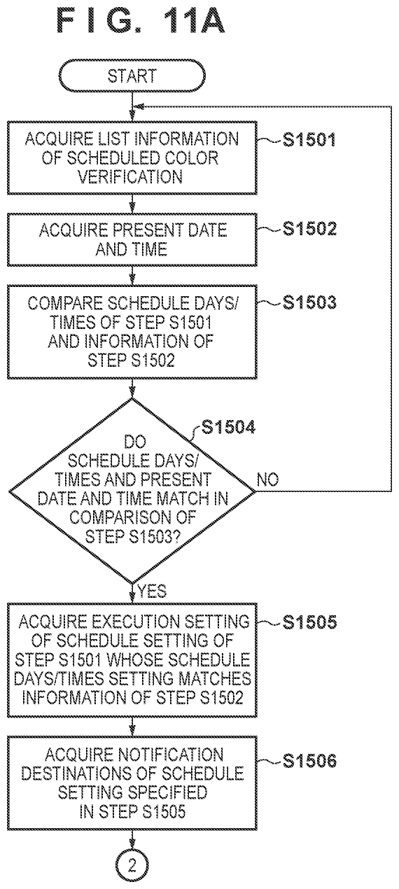

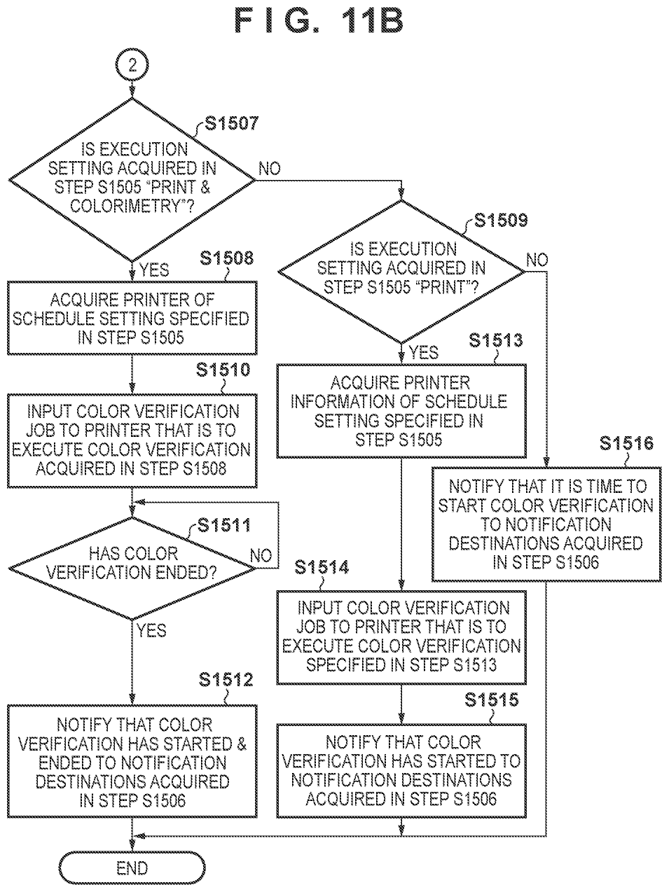

With reference to FIG. 8, FIG. 9, FIGS. 10A and 10B, FIGS. 11A and 11B, a flow of a process for scheduling color verification in the present embodiment will be described.

FIG. 8 is an example of a color verification schedule setting screen used when scheduling a color verification, and FIG. 9 is an example of information stored when a schedule is set. The schedule setting screen of FIG. 8 is displayed on the display unit 205 of the client computer 101 by the CPU 201 of the client computer 101. A schedule setting screen 401 illustrates the entire setting screen which is used when setting a schedule for a color verification. A display 402 indicates that the screen being displayed is a screen for selecting a color reference. A display 403 is a list of reference IDs and reference names for color verification that the system holds. The display 403 displays a list of reference IDs of the item 302 and reference names of the item 303 in the color reference information table 301 of FIG. 4.

A display 404 indicates a screen for setting a schedule for a color reference selected in the color reference list displayed on the display 403. The screen of the display 404 is displayed after an arbitrary color reference is selected in the color reference list of the display 403. A display 405 indicates what color reference the schedule setting is for. In the display 405, a reference name of the color reference selected in the color reference list displayed in the display 403 is displayed. A display 406 indicates an item for selecting the image forming apparatus 102 that performs color verification. The display 407 displays a list of image forming apparatuses 102 which are candidates to be selected for color verification. In the list of the selection candidates of the display 407, the printer names of the item 316 in FIG. 6 are displayed in the list. The list of image forming apparatuses 102 which are selection candidates is displayed in a drop-down list, and the user selects the image forming apparatus 102 to be subjected to color verification from the list.

A display 408 indicates an item for setting the extent to which the color verification is to be performed without a user operation when the color verification is scheduled. A display 409 displays a list of setting item selection candidates for setting the extent to which the color verification is to be performed. The list of setting item selection candidates on the display 409 is displayed in a drop-down list, and the user selects a setting item to be performed from the list. The items displayed at this time vary depending on the capability information (FIG. 6) of the image forming apparatuses 102 to be subjected to the color verification.

A display 410 indicates an item for setting days/times for executing color verification. A display 411 is an item for inputting days/times for executing color verification. A display 412 is an item for setting which days of the week the color verification is to be periodically executed on. A display 413 indicates an item for setting notification destinations for when the scheduled days/times are reached. A display 414 is an item for inputting notification destinations for when the scheduled days/times are reached. In the present example, an example in which e-mail addresses are input as notification destinations is illustrated, and one or more people may be set as the notification destinations.

When a cancel button 415 is pressed, the schedule setting is not performed, and the currently displayed screen is closed. When an OK button 416 is pressed, the current schedule setting is stored in the storage unit 244 of the color management server 117, and the currently displayed screen is closed. In this example, the reference name “company original” is set to be executed on “printer A”. In addition, “print & colorimetry” color verification is set to be carried out at “8:00” “every Monday, Tuesday, Wednesday, and Friday”, and “aaa@mail, bbb@mail” are to be notified when the days/times are reached.

FIG. 9 is a diagram illustrating an example of color verification schedule setting information. The information of FIG. 9 is stored in the storage unit 244 of the color management server 117. A table 417 is a table based on schedule settings set on the schedule setting screen of FIG. 8. An item 418 is ID information for distinguishing a stored schedule setting. Although a four-digit number is illustrated in the present example, it is merely an example, and various other ways of distinguishing the setting such as a combination of random characters may be used. An item 419 is ID information for distinguishing a color reference of the schedule setting. Although a four-digit number is illustrated in the present example, it is merely an example, and various other ways of distinguishing the reference such as a combination of random characters may be used. An item 420 indicates the name of the color reference of the schedule setting. An item 421 indicates a type of the image forming apparatus 102 scheduled to be subjected to color verification. An item 422 indicates an extent to which the scheduled color verification is to be executed. An item 423 indicates a setting of the days/times on which the color verification is to be performed periodically. An item 424 indicates notification destinations for when the scheduled days/times are reached.

FIGS. 10A and 10B are flowcharts illustrating a process at a time of performing a color verification schedule setting. The following process is executed by the CPU 201 of the client computer 101.

In step S501, the CPU 201 of the client computer 101 acquires the color reference set by the user on the color verification schedule setting screen 401 of FIG. 8 from the color management server 117 via the network 118 and stores it in the RAM 202. In step S502, the CPU 201 of the client computer 101 acquires information of the tolerance values of the item 304, and the color patches used in the color reference and reference values therefor from the color reference acquired in step S501. The information of the color patches used in the color reference and the reference values therefor acquired here is the information illustrated in the table 305 of FIG. 5.

In step S503, the CPU 201 of the client computer 101 acquires the information of the image forming apparatus 102 to be subjected to the color verification selected by the user on the display 407 of the schedule setting screen 401 in FIG. 8. In step S504, the CPU 201 of the client computer 101 acquires, via the network 118, the capability information of the image forming apparatus 102 of FIG. 6 stored in the storage unit 244 of the color management server 117 on the basis of the information acquired in step S503, and stores the capability information in the RAM 202.

In step S505, the CPU 201 of the client computer 101 determines whether or not the color verification job can be remotely input based on the capability information of the image forming apparatus 102 acquired in step S504. In other words, for example, it is determined whether or not the image forming apparatus 102 selected from the user supports a JDF job. In a case where the color verification job is determined to be remotely inputtable in step S505, the process proceeds to step S506. In a case where the color verification job is determined to be remotely inputtable in step S505, the process proceeds to step S511.

In step S506, the CPU 201 of the client computer 101, based on capability information of the image forming apparatus 102 acquired in step S504, acquires information of color settings that can be performed remotely for the image forming apparatus 102 selected by the user. The information of the color settings that can be remotely set is the information of the item 318 in FIG. 6.

In step S507, the CPU 201 of the client computer 101, based on capability information of the image forming apparatus 102 acquired in step S506, determines whether or not the color settings necessary in the color verification can be performed remotely for the image forming apparatus 102 selected by the user. In a case where the color settings necessary in the color verification are determined to be remotely settable in step S507, the process proceeds to step S508. In a case where the color settings necessary in the color verification are determined to not be remotely settable in step S507, the process proceeds to step S511.

In step S508, the CPU 201 of the client computer 101, based on capability information of the image forming apparatus 102 acquired in step S506, determines whether or not an automatic colorimetry mechanism is present in the image forming apparatus 102 selected by the user. In a case where it is determined in step S508 that the automatic colorimetry mechanism is present, the process proceeds to step S509. In a case where it is determined in step S508 that there is no automatic colorimetry mechanism, the process proceeds to step S510.

In step S509, the CPU 201 of the client computer 101 displays “print & colorimetry”, “print”, and “notification only” as selection candidates in the display 409 of the schedule setting screen 401 of FIG. 8. In other words, in this case, since the image forming apparatus 102 can execute up to the colorimetry in the color verification without using a user operation, execution is without user operation whichever of the above options is selected.

In step S510, the CPU 201 of the client computer 101 displays “print”, and “notification only” as selection candidates in the display 409 of the schedule setting screen 401 of FIG. 8. In other words, in this case, since the image forming apparatus 102 can execute up to the printing in the color verification without a user operation, the above two options are executed without a user operation.

In step S511, the CPU 201 of the client computer 101 displays “print”, and “notification only” as selection candidates in the display 409 of the schedule setting screen 401 of FIG. 8. That is, in this case, since the image forming apparatus 102 cannot remotely input the color verification job, only the selection candidate of “notification only” is used.

In step S512, the CPU 201 of the client computer 101 stores the execution setting selected by the user on the display 409 in the RAM 202. In step S513, the CPU 201 of the client computer 101 stores the days/times setting of the color verification set by the user in the RAM 202. In step S514, the CPU 201 of the client computer 101 stores the color verification notification destination setting that has been set by the user in the RAM 202.

In step S515, the CPU 201 of the client computer 101 determines whether or not the OK button 416 has been selected in the schedule setting screen 401 of FIG. 8. In a case where it is determined that the OK button 416 has been selected in step S515, the process proceeds to step S516. In a case where it is determined that the OK button 416 has not been selected in step S515, the process proceeds to step S517.

In step S516, the CPU 201 of the client computer 101 stores, in the storage unit 244 of the color management server 117 via the network 118, the schedule setting for the color verification illustrated in the table 417 of FIG. 9, based on the information set in steps S501, S503, S512, S513, and S514. After step S516, the process of FIGS. 10A and 10B is ended.

In step S517, the CPU 201 of the client computer 101 determines whether or not the cancel button 415 has been selected in the schedule setting screen 401 of FIG. 8. In a case where it is determined that the cancel button 415 has been selected in step S517, the process of FIGS. 10A and 10B is ended. On the other hand, in a case where it is determined that the cancel button 415 has not been selected, the process from step S515 is repeated.

FIGS. 11A and 11B are flowcharts illustrating a process executed in a case where a set scheduled time arrives. The following process is executed by the CPU 242 of the color management server 117.

In step S1501, the CPU 242 of the color management server 117 acquires, from the storage unit 244 of the color management server 117, list information for color verification for which a schedule setting illustrated in the table 417 of FIG. 9 has been performed. In step S1502, the CPU 242 of the color management server 117 acquires the present date and time. In step S1503, the CPU 242 of the color management server 117 compares the scheduled days/times of the item 423 in the list information of the scheduled color verification acquired in step S1501 with the present date and time acquired in step S1502. Then, in step S1504, the CPU 242 of the color management server 117 determines whether or not the scheduled days/times acquired in step S1501 and the present date and time acquired in step S1502 match as the result of the comparison in step S1503. In a case where it is determined that the scheduled days/times acquired in step S1501 matches the present date and time acquired in step S1502, the process proceeds to step S1505. In a case where it is determined that the scheduled days/time acquired in step S1501 does not match the present date and time acquired in step S1502, the process from step S1501 is repeated.

In step S1505, the CPU 242 of the color management server 117 specifies the color verification whose scheduled days/times matches the present date and time acquired in step S1502, from the scheduled color verification list information acquired in step S1501, and acquires the execution setting thereof. Note that the acquired execution setting is information of the item 422 in the table 417 in FIG. 9. In step S1506, the CPU 242 of the color management server 117 acquires the notification destinations in the color verification specified in step S1505. Note that the acquired notification destinations are information of the item 424 in the table 417 in FIG. 9.

In step S1507, the CPU 242 of the color management server 117 determines whether or not the execution setting acquired in step S1505 is “print & colorimetry”. In a case where it is determined that the execution setting acquired in step S1505 is “print & colorimetry”, the process proceeds to step S1508. In a case where it is determined that the execution setting acquired in step S1505 is not “print & colorimetry”, the process proceeds to step S1509.

In step S1509, the CPU 242 of the color management server 117 determines whether or not the execution setting acquired in step S1505 is “print”. In a case where it is determined that the execution setting acquired in step S1505 is “print”, the process proceeds to step S1513. In a case where it is determined that the execution setting acquired in step S1505 is not “print”, the process proceeds to step S1516.

In a case where it is determined that the execution setting acquired in step S1505 is “print & colorimetry”, in step S1508, the CPU 242 of the color management server 117 acquires the information of the printer that is to execute the color verification according to the schedule setting specified in step S1505. Note that the acquired printer information is information of the item 421 in the table 417 in FIG. 9. In step S1510, the CPU 242 of the color management server 117 inputs a color verification job to the image forming apparatus 102 corresponding to the information acquired in step S1508, and starts color verification.

In step S1511, the CPU 242 of the color management server 117 determines whether or not the color verification performed in step S1510 has ended. The determination as to whether or not the color verification has ended is based on whether or not the color verification job print processing has been performed, the CPU 242 has received the colorimetry results for the printed color patches, and the comparison between the reference values and the colorimetry results has been completed. In a case where it is determined that the color verification started in step S1510 has ended, the process proceeds to step S1512. In a case where it is determined that the color verification started in step S1510 has not ended, the process of step S1511 is repeated.

In step S1512, the CPU 242 of the color management server 117 notifies the notification destinations acquired in step S1506 that the scheduled color verification was started and has ended. As a notification method, the user is notified by e-mail. However, configuration may be taken to, in addition to the notification by e-mail, notify the user by a pop-up display on their screen in a case where the user associated with an e-mail address of the notification destinations is using the color inspection server 117. After step S1512, the process of FIGS. 11A and 11B is ended.

In a case where it is determined that the execution setting acquired in step S1505 is “print”, in step S1513, the CPU 242 of the color management server 117 acquires the information of the printer that executes the color verification according to the schedule setting specified in step S1505. Note that the acquired printer information is information of the item 421 in the table 417 in FIG. 9. In step S1514, the CPU 242 of the color management server 117 inputs a color verification job to the image forming apparatus 102 corresponding to the information acquired in step S1513, and starts color verification. In step S1515, the CPU 242 of the color management server 117 notifies the notification destinations acquired in step S1506 that the scheduled color verification has started. The notification method may be notification by e-mail, for example, as in the case of step S1512, or may be another method. After step S1515, the process of FIGS. 11A and 11B is ended.

In a case where it is determined that the execution setting acquired in step S1505 is not “print”, in step S1516, the CPU 242 of the color management server 117 notifies the notification destinations acquired in step S1506 that a scheduled day/time at which to start the color verification has arrived. The notification method may be notification by e-mail, for example, as in the case of step S1512, or may be another method. After step S1516, the process of FIGS. 11A and 11B is ended.

As described above, in the present embodiment, when the schedule setting screen 401 of FIG. 8 is displayed, selection candidates for the extent to which the color verification is to be executed without a user operation are displayed based on the capability information of the image forming apparatus 102. The user selects a desired execution setting from the displayed list of color verification execution setting selection candidates, and performs the color verification schedule setting. This enables flexible remote execution of color verification without user operation in accordance with the capability information of the image forming apparatus 102.

### Second Embodiment

Hereinafter, a second embodiment will be described with respect to differences from the first embodiment. In the first embodiment, it is described that only “notification” is displayed as an execution setting selection candidate in a case where the color setting necessary for the color verification is not remotely settable for the image forming apparatus 102, even though a color verification job can be remotely input to the image forming apparatus 102. In this case, since the color verification job can be remotely input, in the present embodiment, the color verification job is input to the image forming apparatus 102 as a job waiting to print without user operation. The user then manually performs the color settings necessary for color verification for the job waiting to print on the image forming apparatus 102, and then the job is executed.

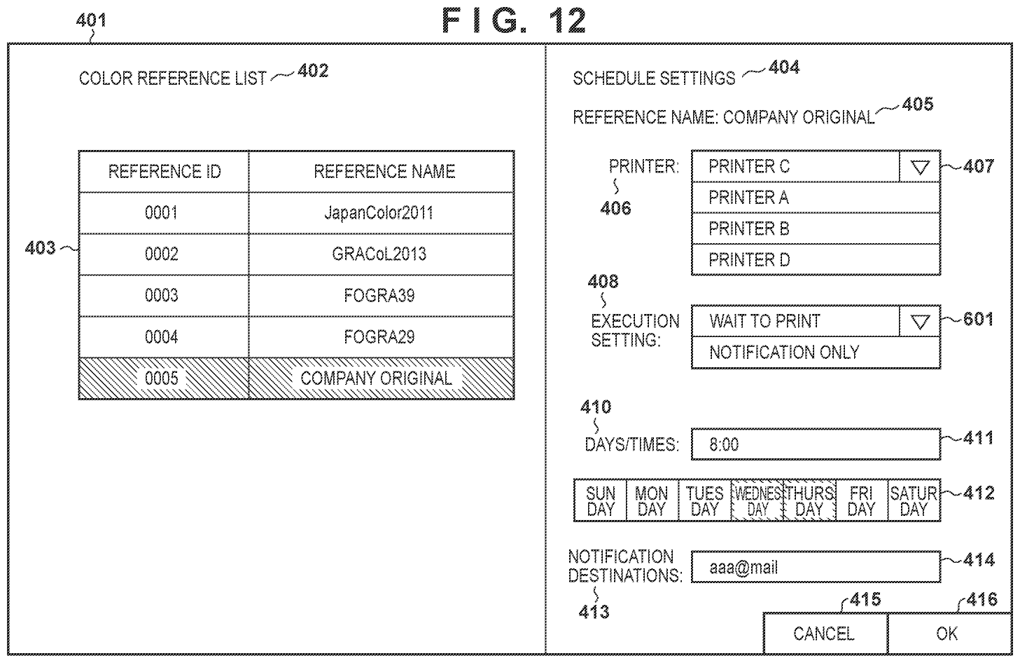

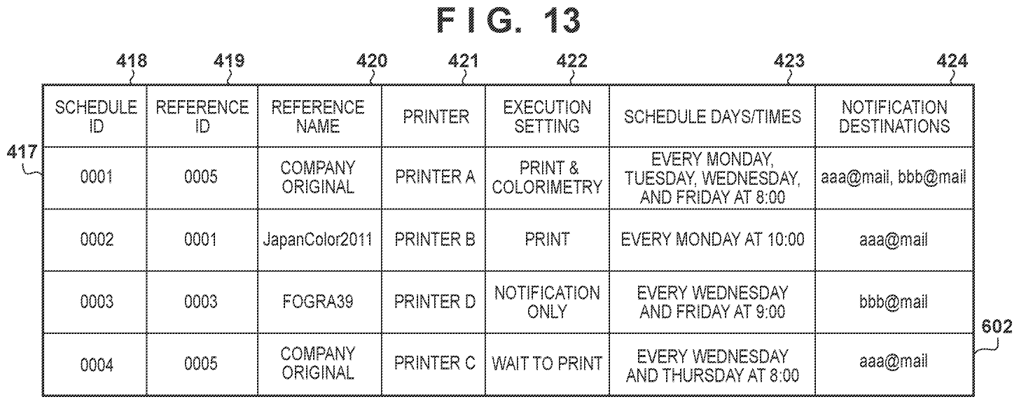

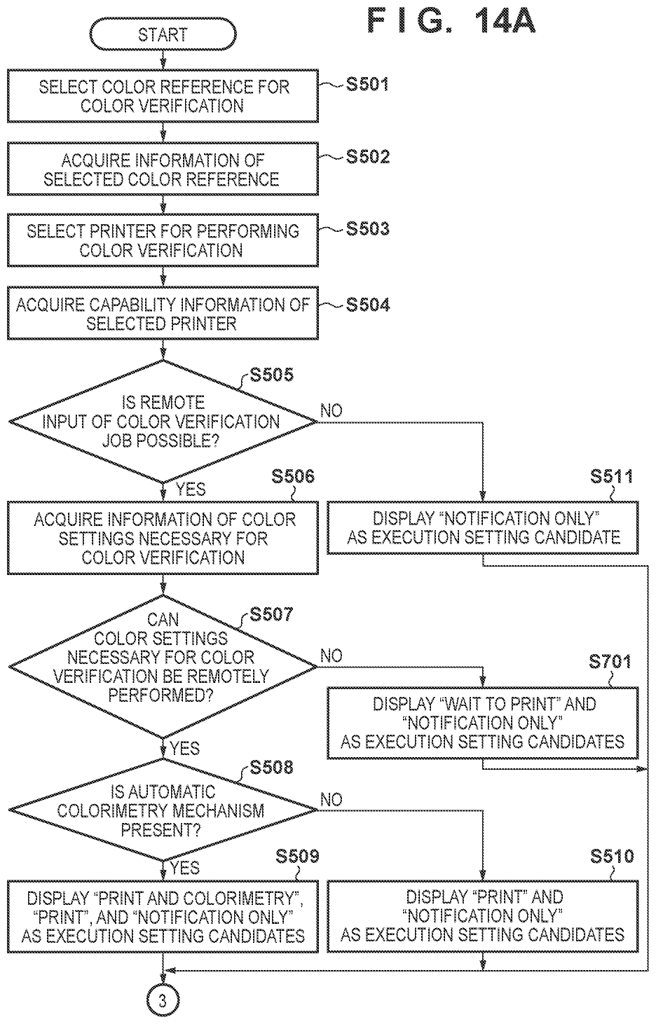

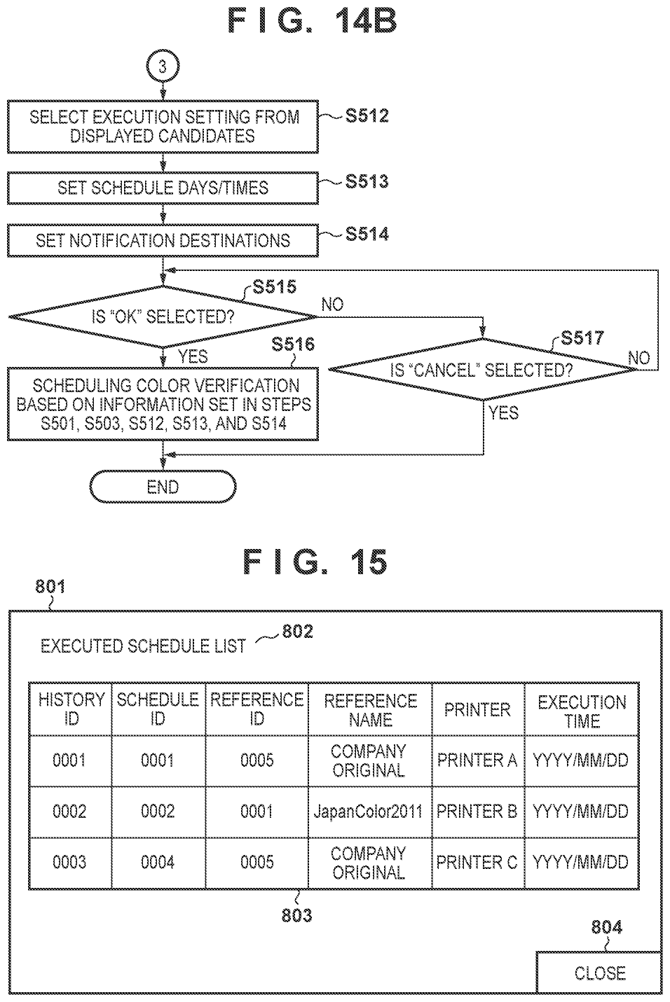

With reference to FIG. 12, FIG. 13, FIGS. 14A and 14B, a flow of a process for scheduling color verification in the present embodiment will be described.

FIG. 12 is a diagram illustrating an example of a color verification schedule setting screen when scheduling color verification. FIG. 13 is a diagram illustrating information stored when a schedule setting is performed. The schedule setting screen of FIG. 12 is displayed on the display unit 205 of the client computer 101 by the CPU 201 of the client computer 101. A display 601 displays a list of setting item selection candidates for setting the extent to which the color verification is to be performed. The list of setting item selection candidates on the display 601 is displayed in a drop-down list, and the user selects a setting item to be performed from the list. In the present example, it can be seen from the information of FIGS. 6 and 7 that the color verification job can be remotely input to the printer C, but the color setting necessary for the color verification cannot be remotely set for the printer C. Therefore, “wait to print” which is input as a job waiting to print in the image forming apparatus 102 and “notification only” are displayed as a list of selection candidates.

FIG. 13 is a diagram illustrating an example of a color verification schedule setting information. The data of FIG. 13 is stored in the storage unit 244 of the color management server 117. The schedule setting 602 indicates an example of the schedule setting in which the execution setting is set to “wait to print”. In this example, “printer C” is set as the image forming apparatus 102 on which color verification is to be performed, and “wait to print” is set as the execution setting.

FIGS. 14A and 14B are flowcharts illustrating a process at a time of performing a color verification schedule setting. The following process is executed by the CPU 201 of the client computer 101. Steps S501 to S517 in FIGS. 14A and 14B are the same as is described for steps S501 to S517 in FIGS. 10A and 10B, and thus the description thereof will be omitted.

In a case where the color setting necessary in color verification is determined to not be remotely settable in step S507, the process proceeds to step S701. In step S701, the CPU 201 of the client computer 101 displays “wait to print”, and “notification only” as selection candidates in the display 601 of the schedule setting screen 401 of FIG. 12. After step S701, the processing advances to step S512.

As described above, in the present embodiment, “wait to print” is displayed as an execution setting selection candidate in a case where the color setting necessary for the color verification is not remotely settable for the image forming apparatus 102, even though the color verification job can be remotely input to the image forming apparatus 102. Thus, even if up to printing of the color verification job cannot be performed remotely, execution can be performed without a user operation up to the inputting of the color verification job to the image forming apparatus 102. Note that the CPU 201 of the client computer 101 may control the print execution in the image forming apparatus 102 so that a command for waiting to print is included in the job. Further, the image forming apparatus 102 may display an editing screen for a job waiting to print on the UI panel 103, and may execute the job when an instruction to execute the job is received from the user on the editing screen.

### Third Embodiment

Hereinafter, a third embodiment will be described with respect to differences from the first and second embodiments. In the first embodiment, when the schedule setting screen 401 of FIG. 8 is displayed, execution setting selection candidates are displayed based on the capability information of the image forming apparatus 102. In the present embodiment, in a case where the color verification is executed according to the execution setting at the scheduled days/times, display is controlled to make a screen to be displayed differ in accordance with the extent to which the color verification has been executed.

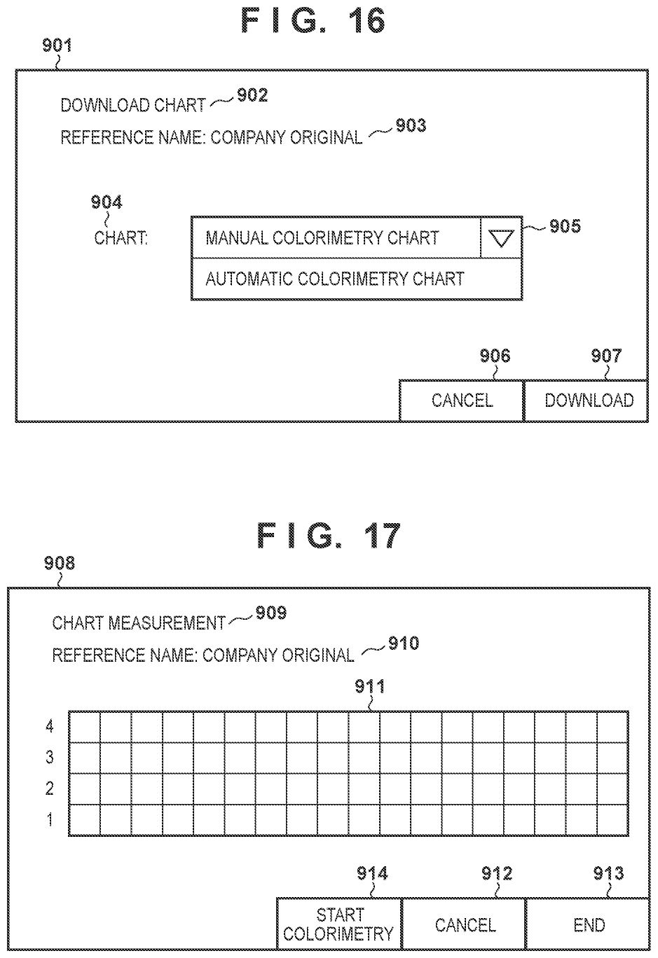

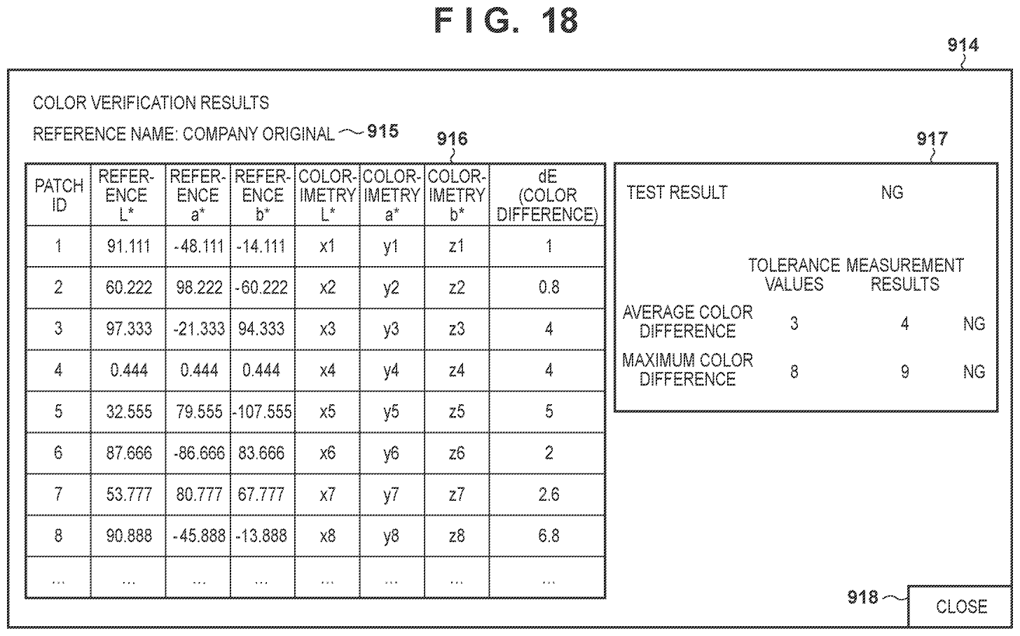

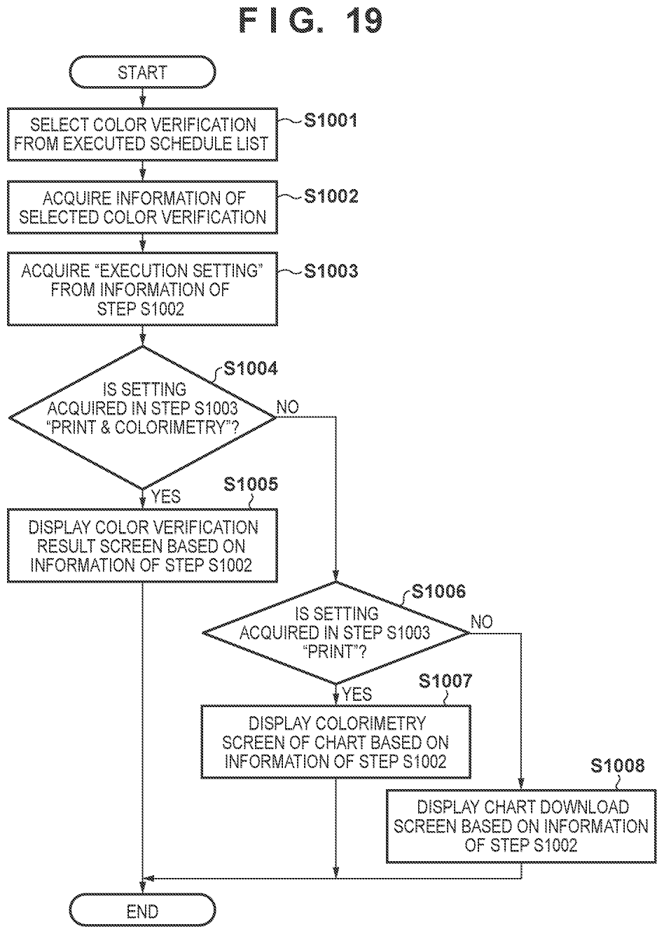

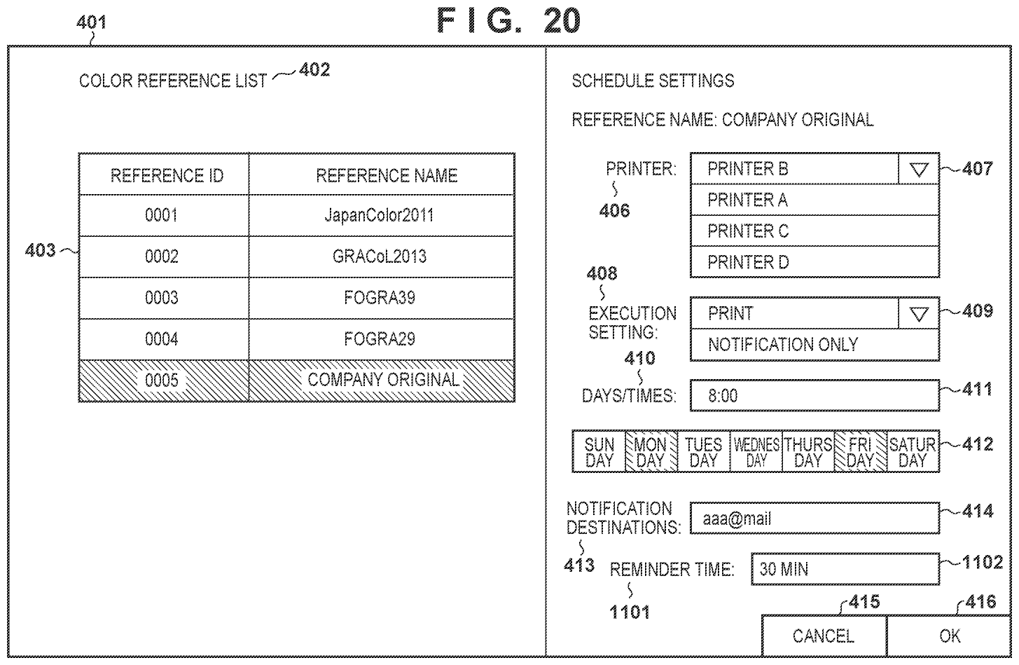

With reference to FIG. 15, FIG. 16, FIG. 17, FIG. 18, and FIG. 19, a flow of a display control process for making a screen to be displayed differ according to the extent to which the color verification has been performed in the present embodiment will be described.

FIG. 15 is a diagram illustrating an example of a screen with a list of scheduled color verifications that have been executed. The screen of FIG. 15 is displayed on the display unit 205 of the client computer 101 by the CPU 201 of the client computer 101. A screen 801 illustrates an entire screen for displaying a list of color verifications executed according to a schedule. The display 802 indicates that the displayed screen is a screen with a list of color verifications executed according to the schedule. A display 803 is a list of color verifications performed according to the schedule. The “history ID” is used to identify the respective histories in the executed color verification list. The “schedule ID” identifies the schedule set in FIG. 8 or FIG. 12. The “reference ID” is ID information for distinguishing a color reference of the schedule setting. Although a four-digit number is illustrated in the present example, it is merely an example, and various other methods of distinguishing the reference such as a combination of random characters may be used. The “reference name” indicates the name of the color reference of the schedule. The “printer” is an item indicating a type of the image forming apparatus 102 that executed the scheduled color verification. The “execution time” indicates the date and time when the scheduled color verification was actually executed. The “execution time” is described as YYYY/MM/DD in the present example; YYYY means year, MM means month, and DD means day, and the actual date and time of execution are entered. This format is only an example, and the present invention is not limited to this format. When a close button 804 is selected, the screen 801 closes.

In the present embodiment, after the schedule setting is executed, one of the screens illustrated in FIGS. 16, 17, and 18 is displayed in accordance with the execution setting in the schedule setting. These screens are displayed on the display unit 205 of the client computer 101 by the CPU 201 of the client computer 101.

FIG. 16 is an example of a screen displayed in a case where “notification only” is set as the execution setting when scheduling the color verification. A screen 901 illustrates an entire screen for downloading a chart for color verification. A display 902 indicates that the displayed screen is a screen for downloading a chart for color verification. A display 903 indicates which color reference a color verification corresponds to. A display 904 indicates an item for selecting the type of chart to be downloaded. A display 905 indicates a list of selection candidates for selecting the type of chart to be downloaded. In this example, two types of charts are displayed in a list: a chart in the case of manual colorimetry, and a chart in the case of automatic colorimetry. When a cancel button 906 is pressed, the screen 901 is closed without downloading the chart. When a download button 907 is pressed, the chart selected in the display 905 is downloaded.

FIG. 17 is an example of a screen displayed in a case where “print” is set as the execution setting when scheduling the color verification. A screen 908 illustrates an entire screen for performing colorimetry on a printed chart for color verification. A display 909 indicates that the screen being displayed is a screen for performing colorimetry on a chart. The display 910 indicates a reference name for identifying which color reference is to be displayed on the current chart colorimetry screen. A display 911 illustrates a preview of chart information based on a color reference. When a colorimetry start button 914 is pressed, colorimetry on the chart is started. When a cancel button 912 is pressed, the colorimetry on the chart is stopped. An end button 913 is activated when the colorimetry is finished for all patches of the chart, and when the end button 913 is pressed after activation, the colorimetry of the chart ends.

FIG. 18 is an example of a screen displayed in a case where “print & colorimetry” is set as the execution setting when scheduling the color verification. A screen 914 illustrates an entire screen for confirming the color verification result. A display 915 indicates the reference name of the color reference used in the color verification. A display 916 displays a table indicating reference values, colorimetry data indicating the results of colorimetry using the colorimetry mechanism, and color differences between the reference values and colorimetry data. Although the colorimetry data is described in the form of x, y, and z in the present example, numerical values are actually included. A display 917 displays a result of comparing color reference tolerance values with colorimetry results with respect to average color difference and maximum color difference. If all of the tolerance values are met, the test result is OK, and if any of the conditions are not met, the test result is NG. When a close button 918 is pressed, the screen 914 closes.

FIG. 19 is a flowchart illustrating a display control process that follows execution of a scheduled color verification. The following process is executed by the CPU 201 of the client computer 101. In step S1001, the CPU 201 of the client computer 101 acquires the executed color verification selected by the user on the executed color verification list screen of FIG. 15 from the color management server 117 via the network 118 and stores it in the RAM 202. In step S1002, the CPU 201 of the client computer 101 acquires information of tolerance values (the item 304 of FIG. 4) of the color verification acquired in step S1001, the color patches used with the color reference and reference values thereof, and the schedule setting data of FIG. 9 (the table 305 of FIG. 5).

In step S1003, the CPU 201 of the client computer 101 acquires the execution setting information of the item 422 based on the schedule setting data acquired in step S1002. In step S1004, the CPU 201 of the client computer 101 determines whether or not the execution setting acquired in step S1003 is “print & colorimetry”. In a case where it is determined that the execution setting acquired in step S1003 is “print & colorimetry”, the process proceeds to step S1005. In a case where it is determined that the execution setting acquired in step S1003 is not “print & colorimetry”, the process proceeds to step S1006.

In step S1005, the CPU 201 of the client computer 101 displays the color verification result screen 914 of FIG. 18 as a screen for displaying that the execution setting acquired in step S1003 is “print & colorimetry”. After that, the process of FIG. 19 is ended.

In step S1006, the CPU 201 of the client computer 101 determines whether or not the execution setting acquired in step S1003 is “print”. In a case where it is determined that the execution setting acquired in step S1003 is “print”, the process proceeds to step S1007. In a case where it is determined that the execution setting acquired in step S1003 is not “print”, the process proceeds to step S1008.

In step S1007, the CPU 201 of the client computer 101 displays the chart colorimetry screen 908 for color verification of FIG. 17 as a screen for displaying that the execution setting acquired in step S1003 is “print”. After that, the process of FIG. 19 is ended. Meanwhile, in step S1008, the CPU 201 of the client computer 101 displays the screen 901 for downloading a chart for the color verification of FIG. 16 as a screen for displaying that the execution setting acquired in step S1003 is “notification only”. After that, the process of FIG. 19 is ended.

As described above, in a case where a scheduled execution setting is executed according to the schedule, the screen to be displayed is made different according to the execution setting. As a result, the user can confirm the result of a color verification executed according to a schedule in accordance with the execution setting or can confirm subsequent steps.

### Fourth Embodiment

Hereinafter, a fourth embodiment will be described with respect to differences from the first and third embodiments. In the first embodiment, in a case where “print and colorimetry” is set in the execution setting when a color verification schedule setting is performed, since the color verification is performed up to colorimetry after printing, there will be no case where a scheduled color verification will be left unaddressed. However, in a case where “print” is set in the execution setting, the execution will be performed up to the printing of the chart for color verification, but the colorimetry must be manually performed by the user, and there is a possibility that the color verification will not be executed. In addition, in a case where “notification only” is set in the execution setting, the user is only notified that the date and time when the color verification is to be executed has come. Therefore, the user must manually perform the color verification from the printing of the chart for the color verification, and there is a possibility that the color verification will not be executed.

In the present embodiment, a setting for performing a reminder notification is executed in a case where the scheduled color verification has not been executed for a predetermined time, when the color verification schedule setting is performed.

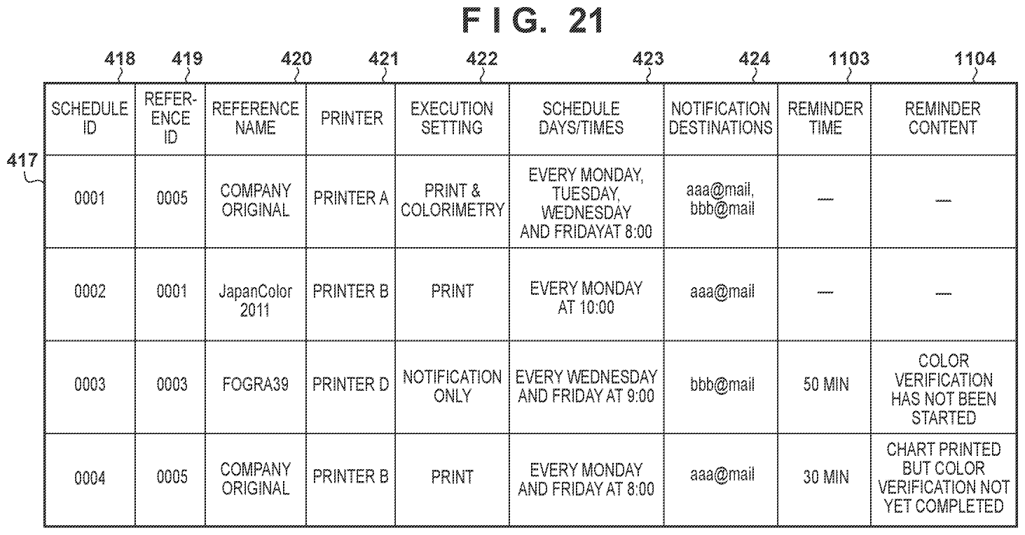

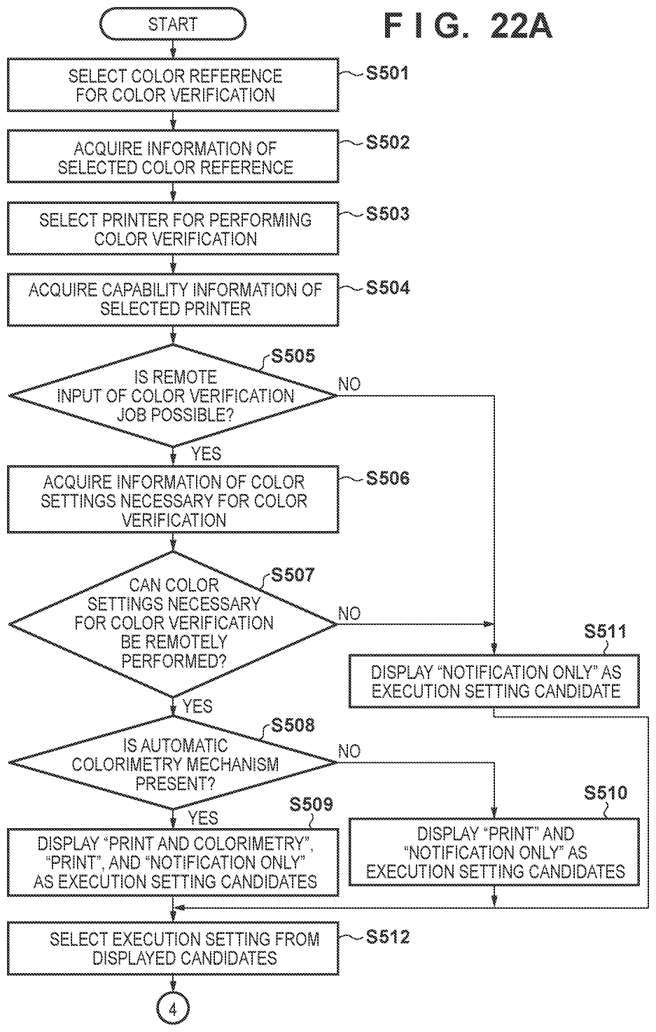

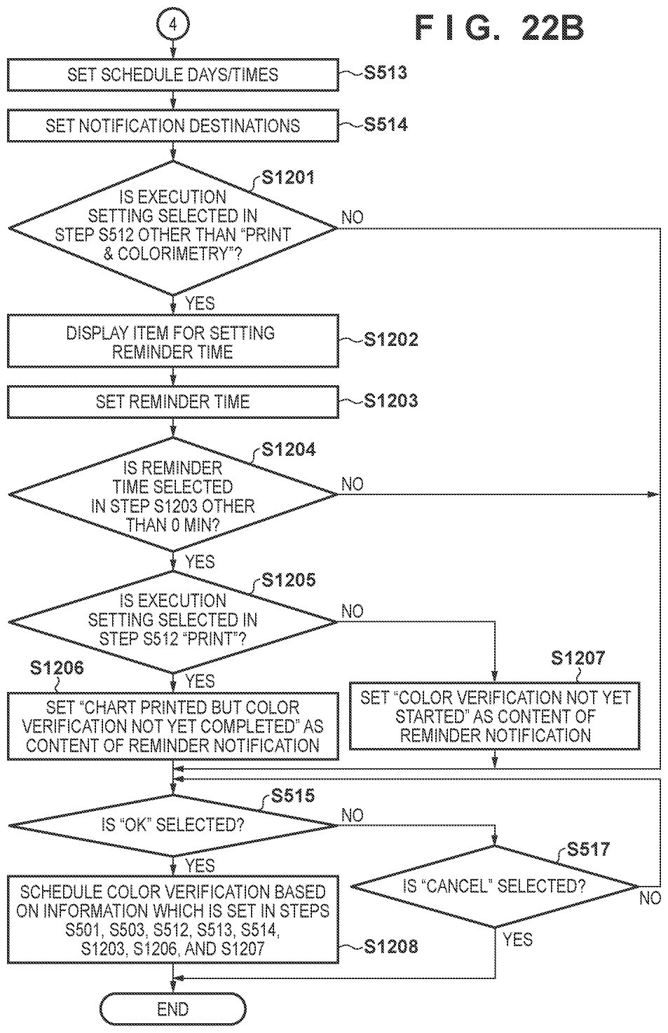

With reference to FIG. 20, FIG. 21, FIGS. 22A and 22B, in the present embodiment, a flow of a process for setting a reminder notification to a user when setting a schedule for a color verification will be described.

FIG. 20 is a diagram illustrating an example of a color verification schedule setting screen when scheduling color verification. FIG. 21 is a diagram illustrating an example of information stored when a schedule setting is performed. The schedule setting screen of FIG. 20 is displayed on the display unit 205 of the client computer 101 by the CPU 201 of the client computer 101. A display 1101 indicates that it is an item for setting a time until a notification as a reminder that a scheduled color verification has not been performed or completed when color verification is scheduled is to be performed. A display 1102 is an item for inputting the time until the notification as a reminder that a scheduled color verification has not been performed or completed when color verification is scheduled is to be performed. In this example, the elapsed time until the reminder (reminder time) is set to be 30 minutes, for example. In this example, the user directly inputs the time, but a list of selection candidates for a predetermined reminder times may be displayed, and the user may select an arbitrary time from the list. In a case where no time is input into the display 1102 or zero minutes is input, a reminder notification is not performed.

FIG. 21 is a diagram illustrating an example of color verification schedule setting information. The data of FIG. 21 is stored in the storage unit 244 of the color management server 117. An item 1103 is an item indicating the reminder time which is the time until the color verification reminder notification is to be performed. The time set in the display 1102 of FIG. 20 is stored. An item 1104 is an item indicating content (a message) to be notified to a user when the reminder notification is executed. In this case, the content (message) to be notified is changed according to the execution setting of the item 422. For example, in a case where the execution setting is “print”, “chart printed but color verification not yet completed” is stored as the content (message) to be notified by the reminder notification. In a case where the execution setting is “notification only”, “color verification has not been started” is stored as the content (message) to be notified by the reminder notification.

FIGS. 22A and 22B are flowcharts illustrating a process of setting a reminder notification to a user when scheduling a color verification. The following process is executed by the CPU 201 of the client computer 101. Steps S501 to S517 in FIGS. 22A and 22B are the same as is described for steps S501 to S517 in FIGS. 10A and 10B, and thus the description thereof will be omitted.

After step S514, in step S1201, the CPU 201 of the client computer 101 determines whether or not the execution setting selected by the user is a setting other than “print & colorimetry”. In a case where it is determined that the execution setting selected by the user is a setting other than “print & colorimetry”, the process proceeds to step S1202. In a case where it is determined that the execution setting selected by the user is a setting other than “print & colorimetry”, that is in a case where it is determined that the execution setting selected by the user is “print & colorimetry”, the process proceeds to step S515.

In step S1202, the CPU 201 of the client computer 101 displays the display 1101 and the item for inputting the reminder time of the display 1102 in FIG. 20. In step S1203, the CPU 201 of the client computer 101 receives the setting of the reminder time from the user. Then, the CPU 201 of the client computer 101 stores the reminder time setting in the RAM 202.

In step S1204, the CPU 201 of the client computer 101 determines whether or not the reminder time set in step S1203 is a time other than zero minutes. In a case where it is determined that the reminder time is a time other than zero minutes, the process proceeds to step S1205. In a case where it is determined that the reminder time is not a time other than zero minutes, that is the reminder time is zero minutes, the process proceeds to step S515.

In step S1205, the CPU 201 of the client computer 101 determines whether or not the execution setting selected by the user is “print”. In a case where it is determined that the execution setting selected by the user is a setting other than “print”, the process proceeds to step S1206. In a case where it is determined that the execution setting selected by the user is not “print”, the process proceeds to step S1207.

In step S1206, the CPU 201 of the client computer 101 stores in the RAM 202 “chart printed but color verification not yet completed” as the content (message) to be notified when the reminder notification is executed. Meanwhile, in step S1207, the CPU 201 of the client computer 101 stores in the RAM 202 “color verification not yet started” as the content (message) to be notified when the reminder notification is executed.

If it is determined in step S515 that the OK button 416 has been selected, the CPU 201 of the client computer 101 creates, in step S1208, the color verification schedule setting information of FIG. 21 based on the information set in steps S501, S503, S512, S513, S1203, S1206, and S1207. Then, the CPU 201 of the client computer 101 stores the created color verification schedule setting information in the storage unit 244 of the color management server 117 via the network 118. After that, the process of FIGS. 22A and 22B is ended.

As described above, according to the present embodiment, it is possible to set the reminder time in a case where the execution setting is “print” or “notification only” when the schedule setting of the color verification is performed. Accordingly, it is possible to reduce cases where a color verification scheduled by the user is not executed.

### Fifth Embodiment

Hereinafter, a fifth embodiment will be described with respect to differences from the first and fourth embodiments. In the first embodiment, in a case where “print” and “notification only” are set for the execution setting during the schedule setting, there is a possibility that a normal job (print job or the like) will be executed while the color verification has not been completed. For example, in the case of a normal print job, the user cannot know whether the executed normal print job has been printed with a normal color quality.

In the present embodiment, when a scheduled day/time for executing the color verification is reached, an execution stop instruction for restricting execution of normal jobs other than the color verification job is transmitted to the image forming apparatus 102. Thus, for example, it is possible to prevent a normal print job from being printed in a situation where the color verification has not been completed.

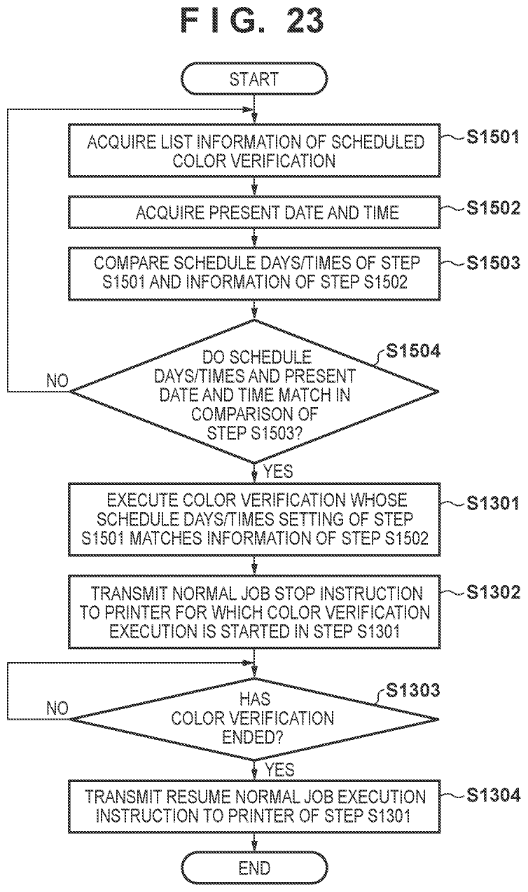

With reference to FIG. 23, a flow of a process for restricting execution of a job other than the color verification job at a scheduled date and time in the present embodiment will be described.

FIG. 23 is a flowchart illustrating a process of restricting execution of a job other than the color verification job at a scheduled date and time. The following process is executed by the CPU 242 of the color management server 117. Steps S1501 to S1504 in FIG. 23 are the same as is described for steps S1501 to S1504 in FIGS. 11A and 11B, and thus the description thereof will be omitted.

In a case where it is determined in step S1504 that the scheduled days/times acquired in step S1501 and the present date and time acquired in step S1502 match, the process proceeds to S1301. In step S1301, the CPU 242 of the color management server 117 specifies the color verification whose scheduled days/time (item 423 of FIG. 21) match the present date and time acquired in step S1502 from among the scheduled color verification list information acquired in step S1501, and starts execution.

In step S1302, the CPU 242 of the color management server 117 transmits, to the image forming apparatus 102 on which the execution of the color verification is started in step S1301, an instruction to stop the execution of normal jobs other than the color verification job via the network 118.

In step S1303, the CPU 242 of the color management server 117 determines whether or not the color verification whose execution is started in step S1301 has ended. The determination of step S1303 is performed in the same manner as step S1511 of FIGS. 11A and 11B. In a case where it is determined that execution of the color verification started in step S1301 has ended, the process proceeds to step S1304. In a case where it is determined that the color verification whose execution is started in step S1301 has not ended, the process of step S1303 is repeated.

In step S1304, the CPU 242 of the color management server 117 transmits, via the network 118, to the image forming apparatus 102 on which the execution of the color verification is started in step S1301, an instruction (resume job execution) to cancel the stoppage of j ob execution in step S1302. After that, the process of FIG. 23 is ended.

As described above, according to the present embodiment, when a scheduled day/time for executing the color verification is reached, an instruction to stop execution of normal jobs other than the color verification job is transmitted to the image forming apparatus 102. Thereby, it is possible to prevent a normal print job from being executed in a situation where the color verification has not been completed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-173655, filed Oct. 28, 2022, which is hereby incorporated by reference herein in its entirety.

What is claimed is:

1. An information processing apparatus, the apparatus comprising:
at least one memory and at least one processor which function as:
an acquisition unit configured to acquire information of an image forming apparatus;
a display control unit configured to, based on the information of the image forming apparatus acquired by the acquisition unit, display a setting screen for setting a schedule by which to execute a color verification,
wherein the color verification includes a plurality of steps, and
the display control unit, based on the information of the image forming apparatus, specifies which steps can be executed without a user operation from the start of the color verification among the plurality of steps, and based on the specified steps, displays on the setting screen a selection candidate for a step to be executed when a scheduled time arrives.

2. The information processing apparatus according to claim 1, further comprising an execution unit configured to execute a selection candidate selected by a user, when the scheduled time arrives.

3. The information processing apparatus according to claim 2, wherein the plurality of steps include: notifying that the color verification is to be executed; printing a chart for the color verification; and performing colorimetry on a printed chart.

4. The information processing apparatus according to claim 3, wherein in a case where the information of the image forming apparatus acquired by the acquisition unit satisfies a first condition, the display control unit displays, on the setting screen, only notify that the color verification is to be executed as a selection candidate.

5. The information processing apparatus according to claim 4, wherein the first condition includes that the image forming apparatus does not support a job in which a step is defined.

6. The information processing apparatus according to claim 4, wherein the first condition includes that the image forming apparatus supports a job in which a step is defined and a color setting necessary for the color verification cannot be set for a job for the color verification transmitted from the information processing apparatus.

7. The information processing apparatus according to claim 3, wherein in a case where the information of the image forming apparatus acquired by the acquisition unit satisfies a second condition, the display control unit displays, on the setting screen, wait to print a chart for the color verification, and notify that the color verification is to be executed as selection candidates.

8. The information processing apparatus according to claim 7, wherein the second condition includes that the image forming apparatus supports a job in which a step is defined and a color setting necessary for the color verification cannot be set for a job for the color verification transmitted from the information processing apparatus.

9. The information processing apparatus according to claim 7, wherein in a case where wait to print a chart for the color verification is selected on the setting screen, the execution unit transmits a job for the color verification to the image forming apparatus.

10. The information processing apparatus according to claim 9, wherein the job for the color verification transmitted to the image forming apparatus is executed on the image forming apparatus after a color setting necessary for the color verification has been set for the job.

11. The information processing apparatus according to claim 3, wherein in a case where the information of the image forming apparatus acquired by the acquisition unit satisfies a third condition, the display control unit displays, on the setting screen, notify that the color verification is to be executed, and print a chart for the color verification, as selection candidates.

12. The information processing apparatus according to claim 11, wherein the third condition includes that: the image forming apparatus supports a job in which a step is defined; and a color setting necessary for the color verification can be set for a job for the color verification transmitted from the information processing apparatus; and the image forming apparatus does not have a colorimetry mechanism.

13. The information processing apparatus according to claim 3, wherein in a case where the information of the image forming apparatus acquired by the acquisition unit satisfies a fourth condition, the display control unit displays, on the setting screen, as selection candidates: notify that the color verification is to be executed; print a chart for the color verification; and print and perform colorimetry on a chart for the color verification.

14. The information processing apparatus according to claim 13, wherein the fourth condition includes that the image forming apparatus supports a job in which a step is defined, and a color setting necessary for the color verification can be set for a job for the color verification transmitted from the information processing apparatus, and the image forming apparatus has a colorimetry mechanism.

15. The information processing apparatus according to claim 3, wherein in a case where a selection candidate selected by the user is executed by the execution unit, the display control unit further displays a screen corresponding to the selection candidate.

16. The information processing apparatus according to claim 15, wherein the screen corresponding to the selection candidate includes a screen related to a step subsequent to the step of the selection candidate.

17. The information processing apparatus according to claim 15, wherein the screen corresponding to the selection candidate includes a screen indicating a result of executing the step of the selection candidate.

18. The information processing apparatus according to claim 2, wherein the setting screen includes a setting of a reminder time.

19. The information processing apparatus according to claim 18, wherein in a case where, after the selection candidate selected by the user is executed by the execution unit, the reminder time has elapsed without the step after the step of the selection candidate being executed, the display control unit further performs a notification as a reminder corresponding to the selection candidate.

20. The information processing apparatus according to claim 2, further comprising a restriction unit configured to restrict execution of another job in the image forming apparatus when the selection candidate selected by the user is executed by the execution unit.

21. The information processing apparatus according to claim 20, further comprising a release unit configured to cancel the restriction on execution of the other job when the plurality of steps end after the execution of the other job is restricted by the restriction unit.

22. A method to be executed on an image forming apparatus, the method comprising:
acquiring information of an image forming apparatus; and
based on the acquired information of the image forming apparatus, displaying a setting screen for setting a schedule by which to execute a color verification,
wherein the color verification includes a plurality of steps, and
based on the information of the image forming apparatus, which steps can be executed without a user operation from the start of the color verification is specified among the plurality of steps, and based on the specified steps, a selection candidate for a step to be executed when a scheduled time arrives is displayed on the setting screen.

23. A non-transitory computer-readable storage medium storing a program configured to cause a computer to function to:
acquiring information of an image forming apparatus; and
based on the acquired information of the image forming apparatus, displaying a setting screen for setting a schedule by which to execute a color verification,
wherein the color verification includes a plurality of steps, and
based on the information of the image forming apparatus, which steps can be executed without a user operation from the start of the color verification is specified among the plurality of steps, and based on the specified steps, a selection candidate for a step to be executed when a scheduled time arrives is displayed on the setting screen.
